(19) United States
(12) Patent Application Publication
(10) Pub. No.: US 2020/0182625 A1
(43) Pub. Date: Jun. 11, 2020

(54) Position Update Method, Position Display Method and Vehicle

(71) Applicant: Ninebot (Beijing) Tech Co., Ltd., Beijing (CN)

(72) Inventors: Yubin YUAN, Beijing (CN); Haiyang LIU, Beijng (CN); Weining XI, Beijing (CN); Zichong CHEN, Beijing (CN); Zhongyuan CHEN, Beijing (CN)

(21) Appl. No.: 16/424,508

(22) Filed: May 29, 2019

(30) Foreign Application Priority Data
Dec. 7, 2018 (CN) 201811497106.1

(51) Int. Cl. G01C 21/30; G06T 7/70; G06T 7/00; H04N 5/225; H04N 5/445; G01S 19/13

(52) U.S. Cl. CPC G01C 21/30; G06T 7/70; G01S 19/13; H04N 5/2253; H04N 5/445; G06T 7/97

(57) ABSTRACT

A position update method, a position display method and a vehicle. The position update method comprises: acquiring information of a target vehicle, wherein the information of the target vehicle comprises a first positioning position of the target vehicle detected by a GPS component of the target vehicle and a real image taken by a photographing device of the target vehicle; updating the first positioning position to a second positioning position according to the real image, wherein the second positioning position is configured to represent a current position of the target vehicle. The position of the target vehicle obtained by the position update method is more accurate, and the problem of low vehicle searching efficiency or difficulty searching caused by inaccurate position of the target vehicle in the prior art can be avoided.

### TECHNICAL FIELD

The present application relates to the field of navigation, and in particular, to a position update method, a position display method and a vehicle.

### BACKGROUND

With the advances of science and technology, city has been increasingly developed, and subway and bus constitutes a large artery of city traffic, and in recent years, the appearance of car hailing, shared bicycles, shared motorcycles and shared electric scooters make people's travel much convenient.

During the actual travel of the application car hailing, the shared bicycle, or the shared electric scooter, the passenger or the worker needs to find the target vehicle by positioning and navigation, and the principle thereof is that the positioning system installed on these vehicles sends the vehicle position to the background server through the communication system. When the passenger or worker sends a request for acquiring the position information of the surrounding vehicle to the background server through the smart phone APP, the background service system sends the position information of the surrounding vehicle to the APP. After the passenger or worker selects the target vehicle, and arrive at the position of the target vehicle with the aid of the APP navigation system.

However, since the existing positioning navigation system has a problem of inaccurate positioning of the position of the target vehicle, it is very easy for the passenger or the worker to walk the wrong way. Alternatively, the topography of the positioning position of the target vehicle may be complicated, and the navigation may only provide an approximate range of the vehicle position; Moreover, sometimes the passenger or worker is not familiar with the road in the vicinity of the target vehicle, and the vehicle needs to be found for a long time even if the passenger or worker has reached the vicinity of the target vehicle. This obviously greatly reduces the vehicle finding efficiency of the passenger or staff, and also reduces the travel efficiency, so that the passenger's travel experience is poor.

The above information disclosed in the background section is merely configured to enhance the understanding of the background of the technology described herein, and therefore, it is possible to contain certain information that is not formed in the state of the art to a person skilled in the art.

### SUMMARY

The main object of the present application is to provide a position update method, a position display method and a vehicle, so as to solve the problem of inaccurate position of an acquired target vehicle in the prior art.

In order to achieve the above object, according to an aspect of the present application, a position update method is provided, the position update method comprises: acquiring information of a target vehicle, wherein the information of the target vehicle comprises a first positioning position of the target vehicle detected by a GPS component of the target vehicle and a real image taken by a photographing device of the target vehicle; updating the first positioning position to a second positioning position according to the real image, wherein the second positioning position is configured to represent a current position of the target vehicle.

Optionally, before acquiring the information of the target vehicle, the method further comprises: acquiring a navigation route generation request, wherein the navigation route generation request is configured to request for acquiring a navigation route from the current position to the target vehicle, and the current position is an issuing position of the navigation route generation request, and after updating the first positioning position to the second positioning position according to the real image, the method further comprises: generating the navigation route according to the second positioning position and the current position.

Optionally, updating the first positioning position to the second positioning position according to the real image comprises: comparing the real image with an image in a predetermined street-view database to obtain a comparison result, wherein the predetermined street-view database records an image and a positioning position where the image is captured, both of which have a mapping relationship with each other; updating the first positioning position to the second positioning position according to the comparison result.

Optionally, updating the first positioning position to the second positioning position according to the comparison result comprises: updating the first positioning position to a target positioning position in the street-view database having a mapping relationship between the target positioning position and the target image, wherein the second positioning position is the target positioning position, when a similarity between the real image and the target image in the street-view database is greater than a first predetermined threshold.

Optionally, comparing the real image with the image in the predetermined street-view database comprises: looking up a set of images in the predetermined street-view database of which a positioning position is less than a second predetermined threshold from the first positioning position; comparing the real image with each image in the set of images respectively.

Optionally, before acquiring the information of the target vehicle, the method further comprises: acquiring a plurality of real images captured by a plurality of vehicles within a predetermined time period, and a positioning position of the plurality of vehicles where the plurality of real images are captured, wherein each of the plurality of the real images maps a positioning position of one of the plurality of the vehicles; establishing the predetermined street-view database with the plurality of real images and positioning positions of the plurality of vehicles, both of which have a mapping relationship with each other.

Optionally, the acquiring the information of the target vehicle comprises: sending a reporting instruction to the target vehicle; acquiring the real image taken and reported by the target vehicle in response to the reporting instruction, and acquiring the first positioning position reported by the target vehicle.

According to another aspect of the present application, there is provided a position display method, comprising: sending a position display request of a target vehicle from a terminal to a server; displaying a position of the target vehicle on a display interface of the terminal, wherein the position of the target vehicle is a second positioning position obtained by updating a first positioning position according to a real image, the first positioning position is a positioning position of the target vehicle detected by the GPS component of the target vehicle, and the real image is an image taken by a photographing device of the target vehicle.

Optionally, after displaying the position of the target vehicle on the display interface of the terminal, the method further comprises: sending a navigation route generation request from the terminal to the server, wherein the navigate route generation request is configured to request for acquiring a navigation route from a current position of the terminal to the target vehicle; acquiring the navigation route from the server, wherein the navigation route is generated according to the current position and the second positioning position; displaying the navigation route on the display interface of the terminal.

Optionally, the displaying the navigation route on the display interface of the terminal comprises: displaying virtual route information in a real-time scene image obtained by a camera of the terminal, wherein the virtual route information is configured to indicate the navigation route.

According to another aspect of the present application, there is provided a navigation route display method, comprising: sending a navigation route generation request from a terminal to a server, wherein the navigation route generation request is configured to request for acquiring a navigation route from a current position of the terminal to a target vehicle; acquiring the navigation route, wherein the navigation route is generated according to the current position and a second positioning position, and the second positioning position is obtained by updating a first positioning position according to the real image; the first positioning position is a positioning position of the target vehicle detected by a GPS component of the target vehicle, and the real image is an image taken by a photographing device of the target vehicle; displaying the navigation route on the terminal.

Optionally, displaying the navigation route on the terminal comprises: displaying virtual route information in a real-time scene image obtained by a camera on the terminal, wherein the virtual route information is configured to indicate the navigation route.

According to another aspect of the present application, a position update apparatus is provided, comprising: a first acquiring unit, configured to acquire information of a target vehicle, wherein the information of the target vehicle comprises a first positioning position of the target vehicle detected by a GPS component of the target vehicle and a real image taken by a photographing device of the target vehicle; an updating unit, configured to update the first positioning position to a second positioning position according to the real image, wherein the second positioning position is configured to represent a current position of the target vehicle.

Optionally, the update apparatus further comprises: a second acquiring unit, configured to acquire a navigation route generation request, wherein the navigation route generation request is configured to request for acquiring a navigation route from a current position to the target vehicle, and the current position is an issuing position of the navigation route generation request; a generating unit, configured to generate the navigation route according to the second positioning position and the current position.

Optionally, the updating unit comprises: a comparison module, configured to compare the real image with an image in a predetermined street-view database to obtain a comparison result, wherein the predetermined street-view database records an image and a positioning position where the image is captured, both of which have a mapping relationship with each other; an updating module, configured to update the first positioning position to the second positioning position according to the comparison result.

Optionally, the updating module is configured to update the first positioning position to a target positioning position in the predetermined street-view database having a mapping relationship between the target positioning position and the target image, wherein the second positioning position is the target positioning position, in a case where a similarity between the real image and the target image in the predetermined street-view database is greater than a first predetermined threshold,

According to another aspect of the present application, there is provided a vehicle, comprising: a body; a photographing device, mounted on the body, the photographing device being configured to take a real image around the vehicle; a GPS component, mounted on the body, the GPS component being configured to acquire a first positioning position of the vehicle; a transmission unit, mounted on the body, the transmission unit being configured to receive and transmit information, wherein the information comprises the first positioning position and the real image; a processor, mounted on the body, the processor being configured to control operation of the GPS component, the photographing device and the transmission unit.

Optionally, the positioning position is a first positioning position, and the real image is configured to update the first positioning position to a second positioning position.

According to another aspect of the present application, there is provided a system, comprising: a vehicle; the first software, as a client, and the first software being used for executing any one of the foregoing methods.

Optionally, the system further comprises: second software as a server, and the second software being used for executing any one of the foregoing methods.

By applying the technical solution of the present application, in the above position update method, firstly, a first positioning position detected by a GPS component and a real image taken by a photographing device are acquired, and then the first positioning position is updated and corrected according to the real image to obtain a relatively accurate second positioning position. The position of the target vehicle obtained by the position update method is more accurate, and the problem of low vehicle searching efficiency or difficulty searching caused by inaccurate position of the target vehicle in the prior art can be avoided.

### BRIEF DESCRIPTION OF THE DRAWINGS

The accompanying drawings, which form a part of the present application, provide a further understanding of the present application, and the schematic embodiments of the present application and the description thereof are used for explaining the present application, and do not constitute an improper limitation to the present application. In the drawings:

FIG. 1 shows a flowchart of an embodiment of a position update method according to the present application;

FIG. 2 shows a flowchart of an embodiment of a position display method according to the present application;

FIG. 3 shows a flowchart of an embodiment of a navigation route display method according to the present application;

FIG. 4 shows a structural block diagram of an embodiment of a position update apparatus according to the present application;

FIG. 5 shows a structural diagram of an embodiment of a vehicle according to the present application; and

FIG. 6 shows an enlarged schematic diagram of the partial structure of FIG. 5.

### DETAILED DESCRIPTION OF THE EMBODIMENTS

It should be noted that the embodiments and the features in the embodiments of the present application can be combined with each other without conflict. Hereinafter, the present application will be described in detail with reference to the accompanying drawings and embodiments.

In order to make those skilled in the art better understand the solutions of the present application, the technical solutions in the embodiments of the present application will be clearly and completely described below with reference to the accompanying drawings in the embodiments of the present application. Apparently, the described embodiments are merely a part of the embodiments of the present application, rather than all of the embodiments. Based on the embodiments in the present application, all other embodiments obtained by those skilled in the art without creative efforts should fall within the scope of protection of the present application.

It should be noted that the terms “first” and “second” and the like in the description and claims of the present application and the figures described above are configured to distinguish similar objects, and do not need to be configured to describe a specific order or precedence order. It is to be understood that the data so used may be interchanged, where appropriate, for the embodiments of the present application described herein. Moreover, the terms “comprising” and “having” and any variation thereof, are intended to cover not exclusively comprising, for example, processes, methods, systems, products or apparatuses comprising a series of steps or units are not necessarily limited to those steps or units that are clearly listed. Instead, other steps or units not expressly listed or inherent to these processes, methods, products or devices may be comprised.

As described above, in the prior art, the position of the target vehicle is inaccurate, which may result in that the worker or the user needs to take a long time to find the vehicle or fail to find the vehicle during the subsequent vehicle finding process, and in order to solve the problem caused by the inaccuracy of the position of the target vehicle, according to the embodiment of the present application, a position update method is provided.

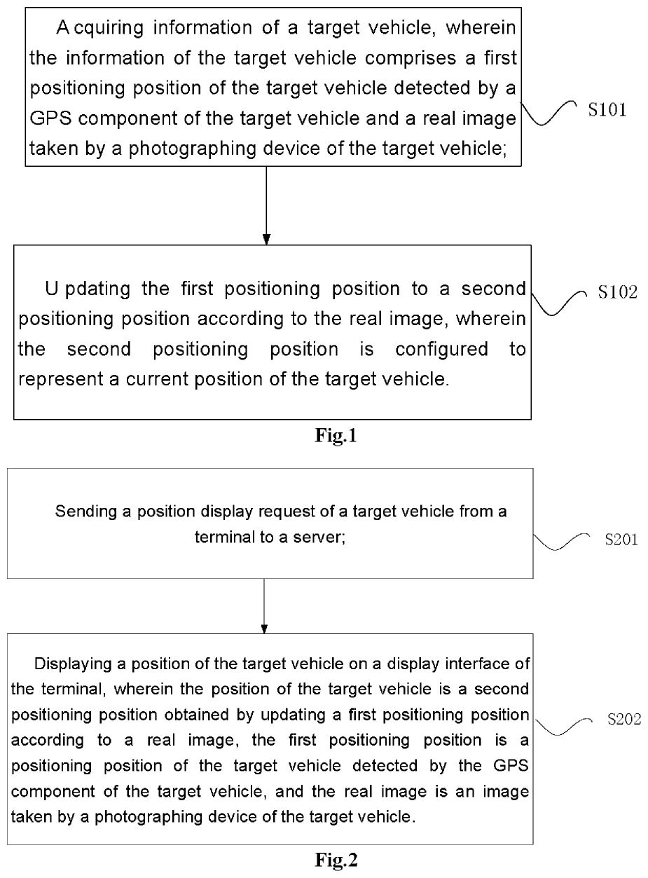

FIG. 1 is a flowchart of a position update method according to an embodiment of the present application. As shown in FIG. 1, the method comprises the following steps:

Step S101, acquiring information of a target vehicle, wherein the information of the target vehicle comprises a first positioning position of the target vehicle detected by a GPS component of the target vehicle and a real image taken by a photographing device of the target vehicle;

Step S102: updating the first positioning position to a second positioning position according to the real image, wherein the second positioning position is configured to represent a current position of the target vehicle.

In the above position update method, firstly, the first positioning position detected by the GPS component and the real image taken by the photographing device are acquired, and then the first positioning position is updated and corrected according to the real image to acquire a relatively accurate second positioning position. The position of the target vehicle obtained by the position update method is more accurate, and the problem of low vehicle searching efficiency or difficulty searching caused by inaccurate position of the target vehicle in the prior art can be avoided.

It should be noted that the steps shown in the flowcharts may be performed in a computer system such as a set of computer-executable instructions, and, although a logical order is shown in the flowcharts, in some cases, the steps shown or described may be performed in an order different from that here.

In a practical application process, even if a user or a worker knows a specific position of the target vehicle, it is difficult to quickly find the target vehicle by means of his/her own force due to poor sense of direction or unfamiliar with the local area, and in order to solve this problem, before acquiring the information of the target vehicle, the method further comprises: acquiring a navigation route generation request, wherein the navigation route generation request is configured to request for acquiring a navigation route from the current position to the target vehicle, and the current position is an issuing position of the navigation route generation request, after updating the first positioning position to the second positioning position according to the real image, the method further comprises: generating the navigation route according to the second positioning position and the current position. In this way, the user or the worker can find the target vehicle more easily according to the navigation route.

The above-mentioned process of updating the first positioning position to the second positioning position according to the real image has a plurality of implementations, and a person skilled in the art would have been able to choose an appropriate method to implement the process according to actual situations, and in a specific embodiment of the present application, updating the first positioning position to the second positioning position according to the real image comprises: comparing the real image with an image in a predetermined street-view database to obtain a comparison result, wherein the predetermined street-view database records an image and a positioning position where the image is captured, both of which have a mapping relationship with each other; updating the first positioning position to the second positioning position according to the comparison result.

Specifically, the real image may be compared with a plurality of images in the predetermined street-view database, and if it is found that a similarity between the real image and a pattern in the predetermined street-view database is greater than a first predetermined threshold, it is determined that the position of the real image is the position of the image in the predetermined street-view database. That is, the first positioning position is updated to a target positioning position having a mapping relationship with the target image in the predetermined street-view database, wherein the second positioning position is the target positioning position. The first predetermined threshold may be selected according to actual requirements, for example, may be set to 95%, 98% or 99%, etc.

In a practical application process, there may be a case that “the similarity between the real image and a plurality of images in the predetermined street-view database is greater than the first predetermined threshold and the similarity is different”, and for this case, a target positioning position corresponding to an image with the largest similarity of the real image is selected as a second positioning position; It is also possible that “the similarity between the real image and the plurality of images in the predetermined street-view database is greater than the first predetermined threshold, and the similarity is the same, and the target positioning positions of the corresponding plurality of images are different”, for this case, the target vehicle can be controlled to acquire the real image at another angle. The real image is compared with the image in the predetermined street-view database until the second positioning position can be determined, or the target vehicle can be controlled to move, and after moving, the corresponding real image and the first positioning position are acquired, and then the real image is compared with the image in the predetermined street-view database until the second positioning position is determined.

In a practical comparison process, it may occur that the similarity between the real image and the image in the predetermined street-view database does not reach the first predetermined threshold, and in this case, the process of comparing the real image with the image in the predetermined street-view database may further comprise: looking up a set of images in the predetermined street-view database of which a positioning position is less than a second predetermined threshold from the first positioning position; comparing the real image with each image in the set of images respectively.

The above-mentioned predetermined street-view database may be an existing street-view database in the prior art, for example, a street-view database of a Baidu map and a street-view database of a Auto Navi map, and may also be a street-view database obtained by photographing of a vehicle within a predetermined time period. In this embodiment, before acquiring information of a target vehicle, the method further comprises: acquiring a plurality of real images captured by a plurality of vehicles within a predetermined time period, and a positioning position of the plurality of vehicles where the plurality of real images are captured, so that data of a predetermined street-view database is more comprehensive, wherein each of the plurality of the real images maps a positioning position of one of the plurality of the vehicles; establishing the predetermined street-view database with the plurality of real images and positioning positions of the plurality of vehicles, both of which have a mapping relationship with each other. In an actual process of establishing the predetermined street-view database, when a plurality of real images and corresponding positioning positions are all the same, choose one real image and corresponding positioning position to establish the predetermined street-view database.

In a specific embodiment of the present application, he acquiring the information of the target vehicle comprises: sending a reporting instruction to the target vehicle; acquiring the real image taken and reported by the target vehicle in response to the reporting instruction, and acquiring the first positioning position reported by the target vehicle. In this way, when the vehicle is required, the first positioning position obtained by sending a reporting instruction to the target vehicle is more accurate.

In a practical application process, it is not limited to acquiring the real image and the first positioning position after sending the reporting instruction, and may also be that the target vehicle sends the first positioning position and the real image thereof at a predetermined frequency.

Specifically, the positioning position update method may be a method executed by the server.

According to another embodiment of the present application, a position display method is provided.

FIG. 2 is a flowchart of a position display method according to an embodiment of the present application. As shown in FIG. 2, the method comprises the following steps:

Step S201, sending a position display request of a target vehicle from a terminal to a server;

Step S202: displaying a position of the target vehicle on a display interface of the terminal, wherein the position of the target vehicle is a second positioning position obtained by updating a first positioning position according to a real image, the first positioning position is a positioning position of the target vehicle detected by the GPS component of the target vehicle, and the real image is an image taken by a photographing device of the target vehicle.

In the above position display method, the position of the target vehicle displayed on the display interface of the terminal is a second positioning position obtained by updating the first positioning position according to the real image, and the position is more accurate with respect to the first positioning position because the update correction is performed according to the real image. The problem of low vehicle searching efficiency or difficulty in searching for a vehicle due to inaccuracy of the position of the target vehicle in the prior art can be avoided.

It should be noted that the steps shown in the flowcharts may be performed in a computer system such as a set of computer-executable instructions, and, although a logical order is shown in the flowcharts, in some cases, the steps shown or described may be performed in an order different from that here.

In a practical application process, even if the user or the worker knows the specific position of the target vehicle, it is difficult to find the target vehicle quickly by his/her own efforts due to poor sense of direction or unfamiliar with the local area, and in order to solve this problem, an embodiment of the present application is provided. After displaying the position of the target vehicle on the display interface of the terminal, the method further comprises: sending a navigation route generation request from the terminal to the server, wherein the navigate route generation request is configured to request for acquiring a navigation route from a current position of the terminal to the target vehicle; acquiring the navigation route from the server, wherein the navigation route is generated according to the current position and the second positioning position; displaying the navigation route on the display interface of the terminal.

In order to make the user or the worker find the target vehicle more quickly, an embodiment of the present application, displaying the navigation route on the display interface of the terminal comprises: displaying virtual route information in a real-time scene image obtained by a camera of the terminal, wherein the virtual route information is configured to indicate the navigation route. As thus, the user or the worker can clearly acquire his/her own direction to walk through the virtual route information, so that can find the corresponding target vehicle more quickly. The display of the virtual route information may be based on the Augment Reality (AR) technology in the prior art.

According to another embodiment of the present application, a navigation route display method is provided.

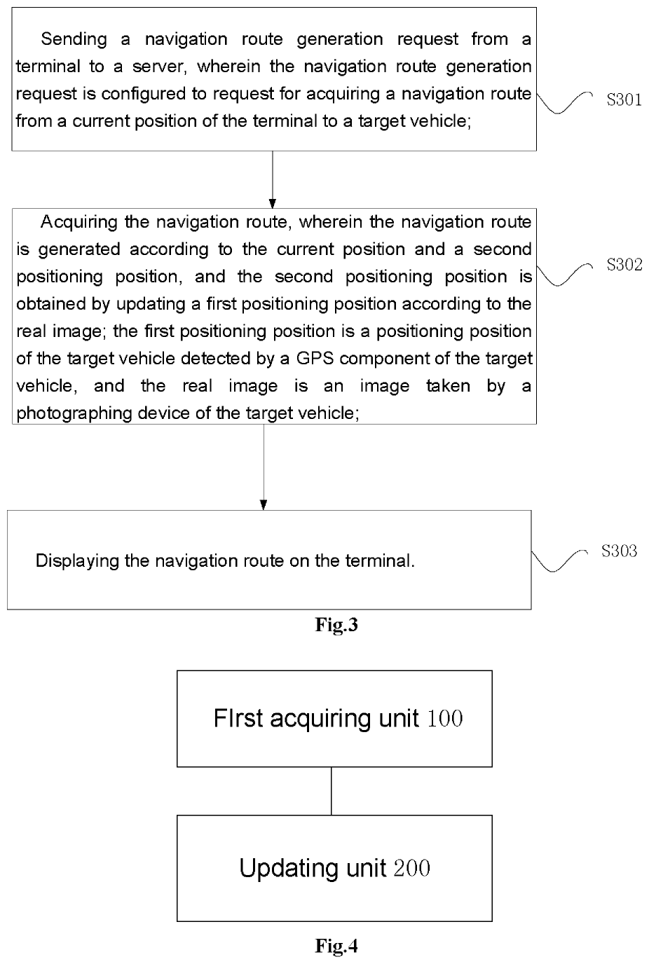

FIG. 3 is a flowchart of a navigation route display method according to an embodiment of the present application. As shown in FIG. 3, the method comprises the following steps:

Step S301, sending a navigation route generation request from a terminal to a server, wherein the navigation route generation request is configured to request for acquiring a navigation route from a current position of the terminal to a target vehicle;

Step S302: acquiring the navigation route, wherein the navigation route is generated according to the current position and a second positioning position, and the second positioning position is obtained by updating a first positioning position according to the real image; the first positioning position is a positioning position of the target vehicle detected by a GPS component of the target vehicle, and the real image is an image taken by a photographing device of the target vehicle;

Step S303: displaying the navigation route on the terminal.

In the above navigation route display method, the navigation route displayed by the terminal is generated according to the current position and the second positioning position, and the second positioning position is obtained by updating the first positioning position according to the real image, and the second positioning position is more accurate than the first positioning position. Thus, the obtained navigation route is also more accurate, and the problem in the prior art that the navigation route is inaccurate due to the inaccuracy of the position of the target vehicle can be avoided.

It should be noted that the steps shown in the flowcharts may be performed in a computer system such as a set of computer-executable instructions, and, although a logical order is shown in the flowcharts, in some cases, the steps shown or described may be performed in an order different from that here.

In order to enable the user or the worker to find a target vehicle more quickly, in an embodiment of the present application, displaying the navigation route on the terminal comprises: displaying virtual route information in a real-time scene image obtained by a camera on the terminal, wherein the virtual route information is configured to indicate the navigation route.

The embodiment of the present application further provides a position update apparatus, and it should be noted that the position update apparatus in the embodiment of the present application may be configured to execute the position update method provided in the embodiment of the present application. Hereinafter, the position update apparatus provided by the embodiment of the present application is introduced.

FIG. 4 is a schematic diagram of a position update apparatus according to an embodiment of the present application. As shown in FIG. 4, the apparatus comprises:

a first acquiring unit 100, configured to acquire information of a target vehicle, wherein the information of the target vehicle comprises a first positioning position of the target vehicle detected by a GPS component of the target vehicle and a real image taken by a photographing device of the target vehicle;

an updating unit 200, configured to update the first positioning position to a second positioning position according to the real image, wherein the second positioning position is configured to represent a current position of the target vehicle.

In the above position update apparatus, the first acquiring unit acquires the first positioning position detected by the GPS component and the real image taken by the photographing device, and then the updating unit updates and corrects the first positioning position according to the real image to acquire a relatively accurate second positioning position. The position of the target vehicle obtained by the position update apparatus is more accurate, and the problem of low vehicle searching efficiency or difficulty searching caused by inaccurate position of the target vehicle in the prior art can be avoided.

In a practical application process, even if the user or the worker knows the specific position of the target vehicle, it is difficult to quickly find the target vehicle by means of his/her own force due to poor sense of direction or unfamiliar with the local area, and in order to solve this problem, an embodiment of the present application is provided. The update apparatus further comprises a second acquiring unit, the second acquiring unit is configured to acquire a navigation route generation request, wherein the navigation route generation request is configured to request for acquiring a navigation route from a current position to the target vehicle, and the current position is an issuing position of the navigation route generation request. The update apparatus further comprises a generating unit, the generating unit is configured to generate the navigation route according to the second positioning position and the current position after updating the first positioning position to the second positioning position according to the real image. As thus, the user or the worker can find the target vehicle more easily according to the navigation route.

The above-mentioned process of updating the first positioning position to the second positioning position according to the real image has a plurality of implementations, and a person skilled in the art would have been able to choose an appropriate method to implement the process according to actual situations, and in a specific embodiment of the present application, the updating unit comprises a comparison module and an updating module, the comparison module is configured to compare the real image with an image in a predetermined street-view database to obtain a comparison result, wherein the predetermined street-view database records an image and a positioning position where the image is captured, both of which have a mapping relationship with each other; an updating module is configured to update the first positioning position to the second positioning position according to the comparison result.

Specifically, the real image may be compared with a plurality of images in the predetermined street-view database, and when it is found that a similarity between the real image and a certain image in the predetermined street-view database is greater than a first predetermined threshold, the position of the real image is determined as the position of the image in the predetermined street-view database. That is, the first positioning position is updated to a target positioning position in the predetermined street database, and the target positioning position has a mapping relationship with the target image, wherein the second positioning position is the target positioning position. The first predetermined threshold may be selected according to actual requirements, for example, may be set to 95%, 98% or 99%, etc.

In a practical comparison process, it may occur that the similarity between the real image and the image in the predetermined street-view database does not reach the first predetermined threshold, then in this case, the comparison module comprises a searching sub-module and a comparison sub-module, wherein the searching sub-module searches in the predetermined street-view database for a set of images with a positioning position that is less than the second predetermined threshold from the first positioning position; The comparison sub-module compares the real image with the images in the set of images respectively.

The above-mentioned predetermined street-view database may be an existing street-view database in the prior art, for example, a street-view database of the Baidu map and a street-view database of the Auto Navi map, or a street-view database obtained by photographing of a vehicle within a predetermined time period, and in this embodiment, the updating unit further comprises a predetermined street-view database. The predetermined street-view database stores the plurality of real images and positioning positions having a mapping relationship with real images of the plurality of vehicles, the plurality of real images and positioning positions having a mapping relationship with real images of the plurality of vehicles, and the plurality of real images are obtained by photographing of a plurality of vehicles within a predetermined time period. The positioning positions of the plurality of vehicles are positioning positions of the plurality of vehicles when the plurality of real images is captured.

In a specific embodiment of the present application, the first acquiring unit comprises a sending module and a first acquiring module, where the sending module is configured to send a reporting instruction to the target vehicle; The first acquiring module is configured to acquire the real image captured and reported by the target vehicle in response to the reporting instruction and the first positioning position reported by the target vehicle.

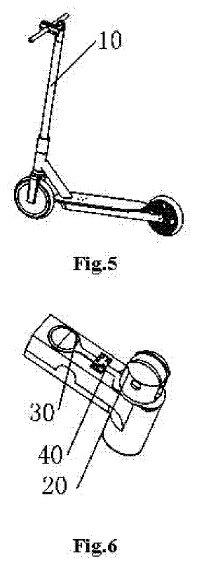

FIG. 5 is a schematic structural diagram of a vehicle according to an embodiment of the present application, and FIG. 6 is a partial enlarged diagram of FIG. 5, as shown in FIGS. 5 and 6, the vehicle comprises:

A body 10; A photographing device 20, mounted on the body, the photographing device being configured to take a real image around the vehicle;

A GPS component 30, mounted on the body, the GPS component being configured to acquire a first positioning position of the vehicle;

A transmission unit 40, mounted on the body, the transmission unit being configured to receive and transmit information, wherein the information comprises the first positioning position and the real image.

The vehicle further comprises a processor (not shown) mounted on the body, and the processor is configured to control operation of the GPS component, the photographing device, and the transmission unit.

The vehicle comprises a GPS component 30 and a photographing device 20. The GPS component 30 may acquire a first positioning position of the vehicle, the photographing device 20 photograph a real image obtained, and the transmission unit 40 sends the first positioning position and the real image to a server. Subsequently, the server updates and corrects the first positioning position according to the real image to acquire a relatively accurate second positioning position.

It should be noted that the GPS component 30, the photographing device 20 and the transmission unit 40 in the present application may be arranged at any feasible position of the body, and a person skilled in the art would have been able to arrange them at different positions of the body according to actual situations, in a specific embodiment. The GPS component, the photographing device and the transmission unit are provided on the handlebar.

An embodiment of the present application further provides a system, the system comprises a vehicle and first software, wherein the first software serves as a client, and the first software is configured to execute the position display method.

By implementing the above-described method, the accurate position of the target vehicle can be acquired, and the problem in the prior art that the vehicle searching efficiency is low or the vehicle is difficult to search is avoided.

In order to enable the user or the worker to find a target vehicle more quickly and efficiently, in an embodiment of the present application, the system further comprises a second software, the second software serves as a server, and the second software is configured to execute the position update method.

The present application can be applied to any applicable scenario, a specific application scenario is an electric scooter, and FIG. 5 also shows an electric scooter. Of course, in addition to the electric scooter, the application scenario of the present application can also be a shared bicycle, a shared motorcycle, etc. A person skilled in the art would have been able to apply the solution of the present application in various scenarios according to actual situations.

The position update apparatus comprises a processor and a memory, and the first acquiring unit and the updating unit are both stored in the memory as program units, and the processor executes the program units stored in the memory to realize corresponding functions.

The processor comprises a kernel, and the kernel acquires a corresponding program unit from a memory. The kernel may be set one or more to accurately obtain the position of the target vehicle by adjusting the kernel parameter.

The memory may comprise non-persistent memory in a computer readable medium, random access memory (RAM) and/or non-volatile memory, such as read only memory (ROM) or flash RAM, the memory comprising at least one memory chip.

An embodiment of the present invention provides a storage medium, on which a program is stored, and the position update method is implemented when the program is executed by a processor.

An embodiment of the present invention provides a processor, where the processor is configured to run a program, and the position update method is executed when the program runs.

An embodiment of the present invention provides an apparatus, where the apparatus comprises a processor, a memory, and a program stored in the memory and executable on the processor, and the processor implements at least the following steps when executing the program:

Step S101, acquiring information of a target vehicle, wherein the information of the target vehicle comprises a first positioning position of the target vehicle detected by a GPS component of the target vehicle and a real image taken by a photographing device of the target vehicle;

Step S102: updating the first positioning position to a second positioning position according to the real image, wherein the second positioning position is configured to represent a current position of the target vehicle.

The devices herein may be servers, PCs, PADs, mobile phones, etc.

The present application further provides a computer program product, which, when executed on a data processing device, is adapted to execute a program initialized with at least the following method steps:

Step S101, acquiring information of a target vehicle, wherein the information of the target vehicle comprises a first positioning position of the target vehicle detected by a GPS component of the target vehicle and a real image taken by a photographing device of the target vehicle;

Step S102: updating the first positioning position to a second positioning position according to the real image, wherein the second positioning position is configured to represent a current position of the target vehicle.

Those skilled in the art will appreciate that embodiments of the present application may be provided as a method, system, or computer program product.

Therefore, the present application may take the form of an entirely hardware embodiment, an entirely software embodiment, or an embodiment combining software and hardware aspects. Moreover, the present application may take the form of a computer program product embodied on one or more computer usable storage media (comprising but not limited to disk memory, CD-ROM, optical memory, etc.) having computer usable program code embodied therein.

The present application is described with reference to flowcharts and/or block diagrams of methods, apparatuses (systems), and computer program products according to embodiments of the present application. It should be understood that each of the flowcharts and/or blocks in the flowcharts and/or block diagrams, as well as combinations of flowcharts and/or blocks in the flowcharts and/or block diagrams, may be implemented by computer program instructions. These computer program instructions may be provided to a processor of a general purpose computer, a special purpose computer, an embedded processor or other programmable data processing apparatus to produce a machine, causing instructions executed by a processor of a computer or other programmable data processing apparatus to generate means for implementing the functions specified in one or more flowcharts and one or more blocks of the flowcharts.

These computer program instructions may also be stored in a computer readable memory capable of directing a computer or other programmable data processing apparatus to function in a particular manner, such that the instructions stored in the computer readable memory produce an article of manufacture comprising instruction means, The instruction means implements the functions specified in one or more flowcharts and one or more blocks of the block diagram.

These computer program instructions may also be loaded onto a computer or other programmable data processing apparatus such that a series of operational steps are performed on the computer or other programmable apparatus to produce computer-implemented processing. Thus, the instructions executed on the computer or other programmable device provide steps for implementing the functions specified in one or more flowcharts and one or more blocks of the flowcharts.

In a typical configuration, the computing device comprises one or more processors (CPUs), input/output interfaces, network interfaces, and memory.

The memory may comprise non-permanent memory in a computer readable medium, random access memory (RAM) and/or non-volatile memory or any combination thereof, such as read only memory (ROM) or flashes RAM. Memory is an example of a computer readable medium.

Computer readable media, comprising permanent and non-permanent, removable and non-removable media, may be implemented by any method or technology for information storage. The information may be computer readable instructions, data structures, modules of programs, or other data. Examples of storage media of a computer comprise: but not limited to phase change memory (PRAM), static random access memory (SRAM), dynamic random access memory (DRAM), other types of random access memory (RAM), read-only memory (ROM), electrically erasable programmable read-only memory (EEPROM), flash memory body or other memory technology, read-only optical disk read-only memory (CD-ROM), digital versatile disc (DVD) or other optical storage, magnetic cassette tape, A magnetic tape disk storage or other magnetic storage device or any other non-transmission medium may be configured to store information that may be accessed by the computing device. As defined herein, computer readable media does not comprise transitory computer readable media such as modulated data signals and carriers.

It should also be noted that the terms “comprising,” “comprising,” or any other variation thereof are intended to encompass non-exclusive inclusion such that processes, methods, goods, or devices comprising a series of elements comprise not only those elements, but also other elements not explicitly listed, or other elements inherent to such processes, methods, goods, or devices. Without more limitation, the elements defined by the statement “comprising one . . . ” do not preclude the presence of additional identical elements in the process, method, merchandise or device comprising the elements.

Those skilled in the art will appreciate that embodiments of the present application may be provided as a method, system, or computer program product. Therefore, the present application may take the form of an entirely hardware embodiment, an entirely software embodiment, or an embodiment combining software and hardware aspects. Moreover, the present application may take the form of a computer program product embodied on one or more computer usable storage media (comprising but not limited to disk memory, CD-ROM, optical memory, etc.) having computer usable program code embodied therein.

From the above description, it can be seen that the embodiments of the present application achieve the following technical effects:

1) In the position update method of the present application, firstly, the first positioning position detected by the GPS component and the real image taken by the photographing device are acquired, and then the first positioning position is updated and corrected according to the real image to acquire a relatively accurate second positioning position. The position of the target vehicle obtained by the position update method is more accurate, and the problem of low vehicle searching efficiency or difficulty searching caused by inaccurate position of the target vehicle in the prior art can be avoided.

2) In the position display method of the present application, the position of the target vehicle displayed on the display interface of the terminal is a second positioning position obtained by updating the first positioning position according to the real image, and the position is more accurate with respect to the first positioning position because the update correction is performed according to the real image. The problem of low vehicle searching efficiency or difficulty in searching for a vehicle due to inaccuracy of the position of the target vehicle in the prior art can be avoided.

3) In the navigation route display method of the present application, the navigation route displayed by the terminal is generated according to the current position and the second positioning position, and the second positioning position is obtained by updating the first positioning position according to the real image, and the second positioning position is more accurate than the first positioning position. Thus, the obtained navigation route is also more accurate, and the problem in the prior art that the navigation route is inaccurate due to the inaccuracy of the position of the target vehicle can be avoided.

4) In the position update apparatus of the present application, the first acquiring unit acquires the first positioning position detected by the GPS component and the real image taken by the photographing device, and then the updating unit updates and corrects the first positioning position according to the real image to acquire a relatively accurate second positioning position. The position of the target vehicle obtained by the position update apparatus is more accurate, and the problem of low vehicle searching efficiency or difficulty searching caused by inaccurate position of the target vehicle in the prior art can be avoided.

5) The vehicle of the present application comprises a GPS component 30 and a photographing device 20; the GPS component 30 may acquire a first positioning position of the vehicle, the photographing device 20 photograph a real image obtained, and the transmission unit 40 sends the first positioning position and the real image to a server. Subsequently, the server updates and corrects the first positioning position according to the real image to acquire a relatively accurate second positioning position.

6) The system of the present application can acquire the accurate position of the target vehicle by executing the method, which can avoid the problem in the prior art that the vehicle searching efficiency is low or the vehicle is difficult to search because the position of the target vehicle is inaccurate.

The above description is merely exemplary embodiments of the present application, and is not intended to limit the present application, and various changes and changes may be made to those skilled in the art. Any modifications, equivalent replacements and improvements made within the spirit and principles of the present application should be comprised within the scope of protection of the present application.

What is claimed is:

1. A position update method, comprising:
acquiring information of a target vehicle, wherein the information of the target vehicle comprises a first positioning position of the target vehicle detected by a GPS component of the target vehicle and a real image taken by a photographing device of the target vehicle;
updating the first positioning position to a second positioning position according to the real image, wherein the second positioning position is configured to represent a current position of the target vehicle.

2. The method according to claim 1, wherein
before acquiring the information of the target vehicle, the method further comprises: acquiring a navigation route generation request, wherein the navigation route generation request is configured to request for acquiring a navigation route from the current position to the target vehicle, and the current position is an issuing position of the navigation route generation request,
after updating the first positioning position to the second positioning position according to the real image, the method further comprises: generating the navigation route according to the second positioning position and the current position.

3. The method according to claim 1, wherein updating the first positioning position to the second positioning position according to the real image comprises:
comparing the real image with an image in a predetermined street-view database to obtain a comparison result, wherein the predetermined street-view database records an image and a positioning position where the image is captured, both of which have a mapping relationship with each other;
updating the first positioning position to the second positioning position according to the comparison result.

4. The method according to claim 3, wherein updating the first positioning position to the second positioning position according to the comparison result comprises:
updating the first positioning position to a target positioning position in the predetermined street-view database having a mapping relationship between the target positioning position and the target image, wherein the second positioning position is the target positioning position, in a case where a similarity between the real image and the target image in the predetermined street-view database is greater than a first predetermined threshold.

5. The method according to claim 3, wherein comparing the real image with the image in the predetermined street database comprises:
looking up a set of images in the predetermined street-view database of which a positioning position is less than a second predetermined threshold from the first positioning position;
comparing the real image with each image in the set of images respectively.

6. The method according to claim 3, wherein before acquiring the information of the target vehicle, the method further comprises:
acquiring a plurality of real images captured by a plurality of vehicles within a predetermined time period, and a positioning position of the plurality of vehicles where the plurality of real images are captured, wherein each of the plurality of the real images maps a positioning position of one of the plurality of the vehicles;
establishing the predetermined street-view database with the plurality of real images and positioning positions of the plurality of vehicles, both of which have a mapping relationship with each other.

7. The method according to claim 1, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

8. The method according to claim 2, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

9. The method according to claim 2, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

10. The method according to claim 3, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

11. The method according to claim 4, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

12. The method according to claim 5, wherein the acquiring the information of the target vehicle comprises:
sending a reporting instruction to the target vehicle;
acquiring the real image taken and reported by the target vehicle in response to the reporting instruction, and acquiring the first positioning position reported by the target vehicle.

13. A position display method, comprising:
sending a position display request of a target vehicle from a terminal to a server;
displaying a position of the target vehicle on a display interface of the terminal, wherein the position of the target vehicle is a second positioning position obtained by updating a first positioning position according to a real image, the first positioning position is a positioning position of the target vehicle detected by the GPS component of the target vehicle, and the real image is an image taken by a photographing device of the target vehicle.

14. The method according to claim 13, wherein after displaying the position of the target vehicle on the display interface of the terminal, the method further comprises:
sending a navigation route generation request from the terminal to the server, wherein the navigate route generation request is configured to request for acquiring a navigation route from a current position of the terminal to the target vehicle;
acquiring the navigation route from the server, wherein the navigation route is generated according to the current position and the second positioning position;
displaying the navigation route on the display interface of the terminal.

15. The method according to claim 14, wherein the displaying the navigation route on the display interface of the terminal comprises:
displaying virtual route information in a real-time scene image obtained by a camera of the terminal, wherein the virtual route information is configured to indicate the navigation route.

16. A vehicle, comprising:
a body;
a photographing device, mounted on the body, the photographing device being configured to take a real image around the vehicle;
a GPS component, mounted on the body, the GPS component being configured to acquire a first positioning position of the vehicle;
a transmission unit, mounted on the body, the transmission unit being configured to receive and transmit information, wherein the information comprises the first positioning position and the real image;
a processor, mounted on the body, the processor being configured to control operation of the GPS component, the photographing device and the transmission unit.

17. The vehicle of claim 16, wherein the positioning position is a first positioning position, and the real image is configured to update the first positioning position to a second positioning position.
